(19) United States
(12) Patent Application Publication
(10) Pub. No.: US 2025/0063549 A1
(43) Pub. Date: Feb. 20, 2025

(54) METHOD AND APPARATUS FOR TRANSMITTING DATA AND CONTROL INFORMATION IN A WIRELESS COMMUNICATION SYSTEM

(71) Applicant: Samsung Electronics Co., Ltd., Gyeonggi-do (KR)

(72) Inventors: Jingxing FU, Beijing (CN); Feifei SUN, Beijing (CN); Zhe CHEN, Beijing (CN); Min WU, Beijing (CN)

(21) Appl. No.: 18/785,717

(22) Filed: Jul. 26, 2024

(30) Foreign Application Priority Data
Aug. 18, 2023 (CN) 202311048856.1

(51) Int. Cl. H04W 72/0446

(52) U.S. Cl. CPC H04W 72/0446

(57) ABSTRACT

The disclosure relates to a 5G or 6G communication system for supporting a higher data transmission rate. A method performed by a UE includes transmitting, to a base station, a first synchronization signal block (SSB) request; determining whether an SSB is detected from the base station; and in case that the SSB is not detected within a first time interval after transmitting the first SSB request, transmitting, to the base station, a second SSB request.

### CROSS-REFERENCE TO RELATED APPLICATION(S)

This application is based on and claims priority under 35 U.S.C. § 119 to Chinese Patent Application Serial No. 202311048856.1, which was filed in the China National Intellectual Property Administration on Aug. 18, 2023, the entire disclosure of which is incorporated herein by reference.

### BACKGROUND

### 1. Field

The present disclosure relates generally to communication technology, and more specifically, to a user equipment (UE) and a base station in a communication system and methods performed the UE and the base station.

### 2. Description of Related Art

5^{th} generation (5G) mobile communication technologies define broad frequency bands such that high transmission rates and new services are possible. For example, these new services can be implemented in “sub 6 gigahertz (GHz)” bands such as 3.5 GHz, and in “above 6 GHz” bands, which may be referred to as mmWave, including 28 GHz and 39 GHz.

In addition, 6^{th} generation (6G) mobile communication technologies (referred to as Beyond 5G systems) are expected to be implemented in terahertz (THz) bands (e.g., 95 GHz to 3THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (e.g., operating multiple subcarrier spacings) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for relatively large amounts of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by newer 5G mobile communication technologies, such as physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, non-terrestrial network (NTN), which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The present disclosure has been made to address at least the disadvantages described above and to provide at least the advantages described below.

According to an aspect of the disclosure, a method is provided for a UE in a communication system. The method includes transmitting, to a base station, a first synchronization signal block (SSB) request; determining whether an SSB is detected from the base station; and in case that the SSB is not detected within a first time interval after transmitting the first SSB request, transmitting, to the base station, a second SSB request.

According to another aspect of the present disclosure, a UE is provided for use in a wireless communication system. The UE includes a transceiver and a processor configured to transmit, to a base station, a first SSB request, determine whether an SSB is detected from the base station, and in case that the SSB is not detected within a first time interval after transmitting the first SSB request, transmit, to the base station, a second SSB request.

According to another aspect of the present disclosure, a method is provided for a base station in a communication system. The method includes receiving, from a UE, a first SSB request; transmitting, to the UE, an SSB; and in case that the SSB is not detected by the UE within a first time interval after transmitting the first SSB request, receiving, from the UE, a second SSB request.

According to another aspect of the present disclosure, a base station is provided for use in a wireless communication system. The base station includes a transceiver and a processor configured to receive, from a UE, a first SSB request, transmit, to the UE, an SSB, and in case that the SSB is not detected by the UE within a first time interval after transmitting the first SSB request, receive, from the UE, a second SSB request.

### BRIEF DESCRIPTION OF THE DRAWINGS

The above and other aspects, features and advantages of certain embodiments of the disclosure will be more apparent from the following detailed description taken in conjunction with the accompanying drawings, in which:

FIG. 1 illustrates a wireless network according to an embodiment;

FIGS. 2A and 2B respectively illustrate examples of a wireless transmission path and a wireless reception path according to an embodiment;

FIG. 3A illustrates a UE according to an embodiment;

FIG. 3B illustrates a base station according to an embodiment;

FIG. 4 is a flow diagram illustrating a method performed by a UE according to an embodiment;

FIG. 5 illustrates a method performed by a UE according to an embodiment;

FIG. 6 illustrates a method performed by a UE according to an embodiment;

FIG. 7 illustrates a method performed by a UE according to an embodiment;

FIG. 8 illustrates a method performed by a UE according to an embodiment;

FIG. 9 illustrates a UE according to an embodiment;

FIG. 10 illustrates a UE according to an embodiment; and

FIG. 11 illustrates a base station or core network entity according to an embodiment.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are used to provide a clear and consistent understanding of the present disclosure. It should be apparent to those skilled in the art that the following description of various embodiments of the present disclosure is provided for illustration purpose only and not for the purpose of limiting the present disclosure as defined by the appended claims and their equivalents.

Herein, the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” may include any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

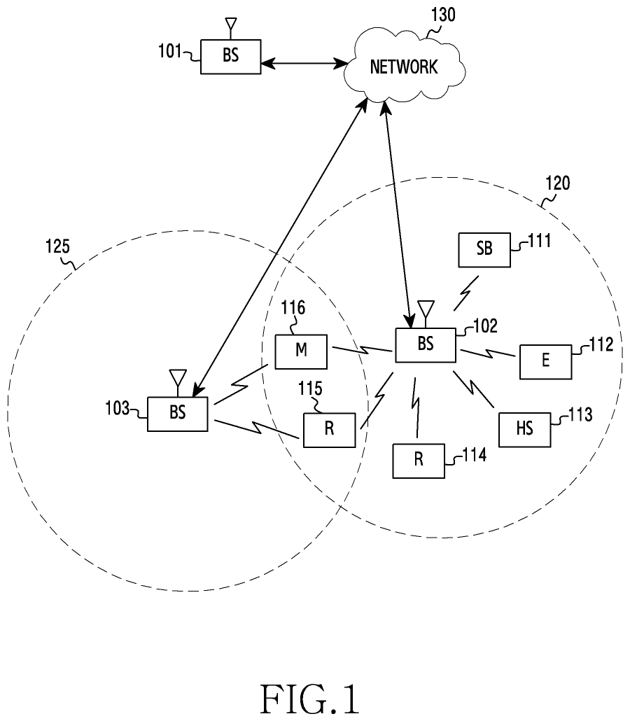

FIG. 1 illustrates a wireless network according to an embodiment.

Referring to FIG. 1, the wireless network includes a gNodeB (gNB) 101, a gNB 102, and a gNB 103. The gNB 101 communicates with the gNB 102 and the gNB 103. The gNB 101 also communicates with at least one Internet protocol (IP) network 130, such as the Internet, a private IP network, or other data networks.

Depending on a type of the network, other well-known terms such as “base station (BS)” or “access point” can be used instead of “gNodeB” or “gNB”. For convenience, the terminology “gNodeB” or “gNB” is used herein to refer to network infrastructure components that provide wireless access for remote UEs.

Additionally, depending on the type of the network, instead of “UE”, other well-known terms such as “mobile station”, “user station”, “remote terminal”, “wireless terminal” or “user apparatus” can be used. For convenience, the term UE is used in this patent document to refer to a remote wireless device that wirelessly accesses a gNB, regardless of whether the UE is a mobile device (such as a mobile phone or a smart phone) or a fixed device (such as a desktop computer or a vending machine).

The gNB 102 provides wireless broadband access to the network 130 for a first plurality of UEs within a coverage area 120 of the gNB 102. The first plurality of UEs include a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); a UE 116, which may be a mobile (M) device, such as a cellular phone, a wireless laptop computer, a wireless personal digital assistant (PDA), etc.

The gNB 103 provides wireless broadband access to network 130 for a second plurality of UEs within a coverage area 125 of gNB 103. The second plurality of UEs include the UE 115 and the UE 116. One or more of gNBs 101-103 can communicate with each other and with UEs 111-116 using 5G, long term evolution (LTE), LTE-advanced (A), WiMAX, etc.

In FIG. 1, the dashed lines represent approximate ranges of the coverage areas 120 and 125, and the ranges are shown as approximate circles merely for illustration and explanation purposes. For example, the coverage areas 120 and 125 may have other shapes, including irregular shapes, depending on configurations of the gNBs 101-103 and changes in the radio environment associated with natural obstacles and man-made obstacles.

One or more of the gNB 101, the gNB 102, and the gNB 103 include a 2-dimensional (2D) antenna array. One or more of the gNB 101, the gNB 102, and the gNB 103 support codebook designs and structures for systems with 2D antenna arrays.

FIG. 1 illustrates an example of a wireless network, and various changes can be made to FIG. 1. For example, the wireless network may include any number of gNBs and any number of UEs in any suitable arrangement. Further, the gNB 101 may directly communicate with any number of UEs and provide wireless broadband access to the network 130 for those UEs. Similarly, each of the gNBs 102-103 can directly communicate with the network 130 and provide direct wireless broadband access to the network 130 for the UEs. In addition, the gNBs 101, 102 and/or 103 can provide access to other or additional external networks, such as external telephone networks or other types of data networks.

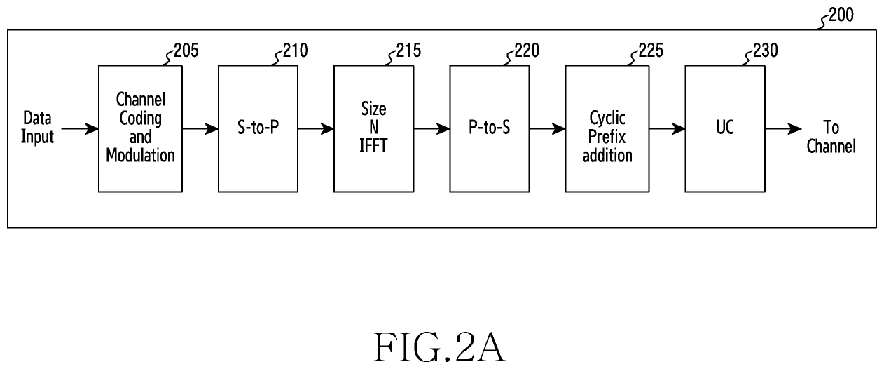

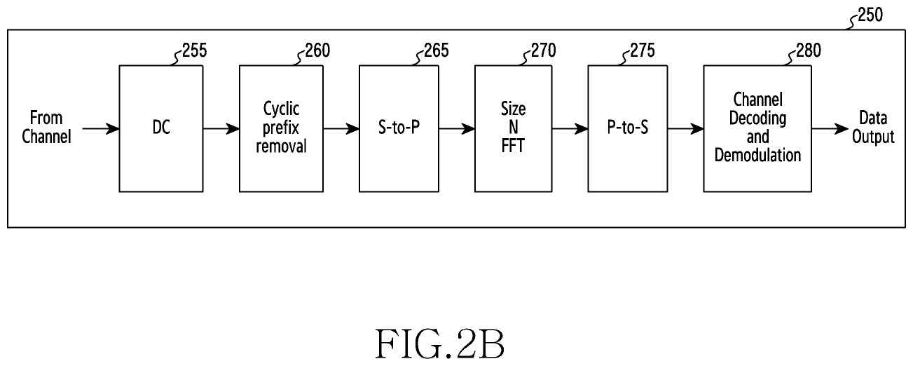

FIGS. 2A and 2B respectively illustrate a wireless transmission path and a wireless reception path according to an embodiment.

Referring to FIGS. 2A and 2B, the transmission path 200 may be implemented in a gNB, e.g., the gNB 102 as illustrated in FIG. 1, and the reception path 250 may be implemented in a UE, e.g., the UE 116 as illustrated in FIG. 1. However, the reception path 250 may also be implemented in a gNB and the transmission path 200 can be implemented in a UE. The reception path 250 may be configured to support codebook designs and structures for systems with 2D antenna arrays.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, an S-to-P block 265, a size N fast Fourier transform (FFT) block 270, a P-to-S block 275, and a channel decoding and demodulation block 280.

In the transmission path 200, the channel coding and modulation block 205 receives a set of information bits, applies coding (such as LDPC coding), and modulates the input bits (e.g., using quadrature phase shift keying (QPSK) or quadrature amplitude modulation (QAM)) to generate a sequence of frequency-domain modulated symbols. The S-to-P block 210 converts (e.g., demultiplexes) serial modulated symbols into parallel data to generate N parallel symbol streams, where N is a size of the IFFT/FFT used in the gNB and the UE. The size N IFFT block 215 performs IFFT operations on the N parallel symbol streams to generate a time-domain output signal. The P-to-S block 220 converts (e.g., multiplexes) parallel time-domain output symbols from the size N IFFT block 215 to generate a serial time-domain signal. The cyclic prefix addition block 225 inserts a cyclic prefix into the time-domain signal. The UC 230 modulates (e.g., up-converts) the output of the cyclic prefix addition block 225 to a radio frequency (RF) for transmission via a wireless channel. The signal can also be filtered at a baseband before switching to the RF frequency.

The RF signal transmitted from gNB arrives at the UE 116 after passing through the wireless channel, and operations in reverse to those performed at the gNB are then performed at the UE.

More specifically, the DC 255 down-converts the received signal to a baseband frequency, and the cyclic prefix removal block 260 removes the cyclic prefix to generate a serial time-domain baseband signal. The S-to-P block 265 converts the time-domain baseband signal into a parallel time-domain signal. The size N FFT block 270 performs an FFT algorithm to generate N parallel frequency-domain signals. The P-to-S block 275 converts the parallel frequency-domain signal into a sequence of modulated data symbols. The channel decoding and demodulation block 280 demodulates and decodes the modulated symbols to recover the original input data stream.

Additionally, each of the gNBs 101-103 may implement a transmission path 200 similar to that for transmitting to the UEs 111-116 in the downlink, and may implement a reception path 250 similar to that for receiving from the UEs 111-116 in the uplink. Similarly, each of the UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using hardware, or using a combination of hardware and software/firmware. For example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although FIGS. 2A and 2B are described as using FFT and IFFT, this is only an illustrative example and should not be interpreted as limiting the scope of the present disclosure. Other types of transforms can be used, such as discrete Fourier transform (DFT) and inverse discrete Fourier transform (IDFT) functions. For DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements.

Furthermore, while FIGS. 2A and 2B are provided to illustrate examples of types of transmission and reception paths that can be used in a wireless network, other suitable architecture can be used to support wireless communication in a wireless network.

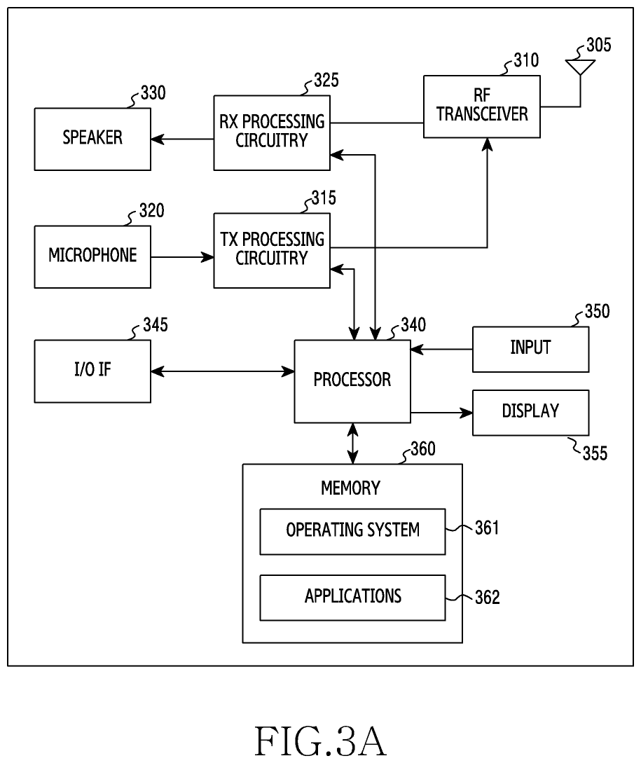

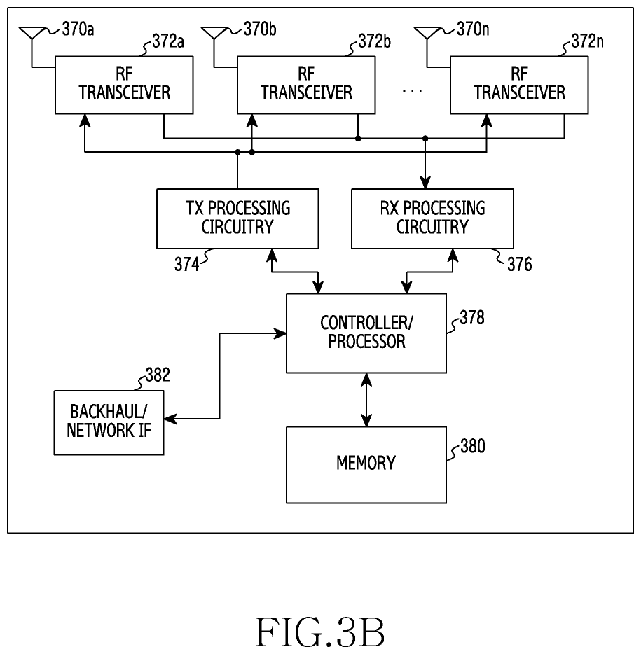

FIG. 3A illustrates a UE according to an embodiment. For example, the UEs 111-116 of FIG. 1 may have the same or similar configuration as the UE illustrated in FIG. 3A.

Referring to FIG. 3A, the UE includes an antenna 305, an RF transceiver 310, a transmission (TX) processing circuit 315, a microphone 320, a reception (RX) processing circuit 325, a speaker 330, a processor/controller 340, an input/output (I/O) interface 345, an input device 350, a display 355, and a memory 360. The memory 360 includes an operating system (OS) 361 and one or more applications 362.

The RF transceiver 310 receives an incoming RF signal transmitted by a gNB of the wireless network through the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding, and/or digitizing the baseband or IF signal. The RX processing circuit 325 transmits the processed baseband signal to the speaker 330 (e.g., for voice data) or to the processor/controller 340 for further processing (e.g., for web browsing data).

The TX processing circuit 315 receives analog or digital voice data from the microphone 320 or other outgoing baseband data (e.g., network data, email or interactive video game data) from the processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal to be transmitted via the antenna 305.

The processor/controller 340 can include one or more processors or other processing devices and execute the OS 361 stored in the memory 360 in order to control the overall operation of the UE. For example, the processor/controller 340 can control reception of forward channel signals and transmission of backward channel signals through the RF transceiver 310, the RX processing circuit 325, and the TX processing circuit 315. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to the I/O interface 345, which provides the UE with the ability to connect to other devices such as laptop computers and handheld computers. The I/O interface 345 is a communication path between these accessories and the processor/controller 340.

The processor/controller 340 is also coupled to the input device 350 and the display 355.

An operator of the UE can input data into the UE using the input device 350. The display 355 may be a liquid crystal display (LCD) or other display capable of presenting text and/or at least limited graphics (e.g., from a website).

The memory 360 is coupled to the processor/controller 340. A part of the memory 360 can include a random access memory (RAM), while another part of the memory 360 can include a flash memory or other read-only memory (ROM).

Various changes can also be made to FIG. 3A. For example, various components in FIG. 3A can be combined, further subdivided or omitted, and additional components can be added according to specific requirements. For example, the processor/controller 340 can be divided into a plurality of processors, such as one or more central processing units (CPUs) and one or more graphics processing units (GPUs). Furthermore, although FIG. 3A illustrates a UE configured as a mobile phone or a smart phone, UEs can be configured to operate as other types of mobile or fixed devices.

FIG. 3B illustrates a gNB according to an embodiment. For example, the gNB 102 of FIG. 1 may be configured like the gNB illustrated in FIG. 3B.

Referring to FIG. 3B, the gNB includes a plurality of antennas 370a-370n, a plurality of RF transceivers 372a-372n, a TX processing circuit 374, and a RX processing circuit 376. One or more of the plurality of antennas 370a-370n may include a 2D antenna array.

The gNB also includes a controller/processor 378, a memory 380, and a backhaul or network interface 382.

The RF transceivers 372a-372n receive an incoming RF signal from the antennas 370a-370n, such as a signal transmitted by UEs or other gNBs. The RF transceivers 372a-372n down-convert the incoming RF signal to generate an IF or baseband signal. The IF or baseband signal is transmitted to the RX processing circuit 376, which generates a processed baseband signal by filtering, decoding and/or digitizing the baseband or IF signal. The RX processing circuit 376 transmits the processed baseband signal to the controller/processor 378 for further processing.

The TX processing circuit 374 receives analog or digital data (e.g., voice data, network data, email or interactive video game data) from the controller/processor 378. The TX processing circuit 374 encodes, multiplexes, and/or digitizes outgoing baseband data to generate a processed baseband or IF signal.

The RF transceivers 372a-372n receive the outgoing processed baseband or IF signal from the TX processing circuit 374 and up-convert the baseband or IF signal into an RF signal to be transmitted via antennas 370a-370n.

The controller/processor 378 can include one or more processors or other processing devices that control the overall operation of the gNB. For example, the controller/processor 378 can control the reception of forward channel signals and the transmission of backward channel signals through the RF transceivers 372a-372n, the RX processing circuit 376, and the TX processing circuit 374. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. The controller/processor 378 may support any of a variety of other functions in the gNB. In some embodiments, the controller/processor 378 includes at least one microprocessor or microcontroller.

The controller/processor 378 is also capable of executing programs and other processes residing in the memory 380, such as an OS. The controller/processor 378 can also support channel quality measurement and reporting for systems with 2D antenna arrays.

In some embodiments, the controller/processor 378 supports communication between entities, such as web real-time communication (RTC) entities. The controller/processor 378 can move data into or out of the memory 380 as required by an execution process.

The controller/processor 378 is also coupled to the backhaul or network interface 382. The backhaul or network interface 382 allows the gNB to communicate with other devices or systems through a backhaul connection or through a network. The backhaul or network interface 382 can support communication over any suitable wired or wireless connection(s). For example, when the gNB is implemented as a part of a cellular communication system, such as a cellular communication system supporting 5G or new radio access technology or NR, LTE or LTE-A, the backhaul or network interface 382 can allow the gNB to communicate with other gNBs through wired or wireless backhaul connections. When the gNB is implemented as an access point, the backhaul or network interface 382 can allow the gNB to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include a RAM, while another part of the memory 380 can include a flash memory or other ROMs. In certain embodiments, a plurality of instructions, such as a BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of the gNB implemented using the RF transceivers 372a-372n, the TX processing circuit 374, and/or the RX processing circuit 376 support aggregated communication with frequency division duplex (FDD) cells and time division duplex (TDD) cells.

Various changes may also be made to FIG. 3B. For example, a gNB can include any number of each component illustrated in FIG. 3A. For example, the access point can include many backhaul or network interfaces 382, and the controller/processor 378 can support routing functions to route data between different network addresses.

As another example, although the gNB is illustrated as including only one TX processing circuit 374 and one RX processing circuit 376, the gNB can include multiple instances of each component (e.g., one for each RF transceiver).

When required to access a system, a UE may detect an SSB broadcast by a base station to implement downlink synchronization or perform access. The SSB may include a primary synchronization signal (PSS), a secondary synchronization signal (SSS), and a physical broadcast channel (PBCH). The PBCH may include a demodulation reference signal (DMRS) for PBCH demodulation.

However, the base station may consume excess power to constantly transmit the SSB in order for the UE to detect the SSB when required to access the system. Therefore, according to an embodiment of the disclosure, instead of constantly transmitting the SSB, a base station may transmit the SSB only when the UE is required to access the system. At this point, the UE may transmit SSB request information, and the base station transmits the SSB in response to receiving the SSB request information.

However, after the UE transmits the SSB request information, it is possible that the SSB request information transmitted by the UE is not received by the base station. In this case, the UE may re-transmit the SSB request information in order to meet the requirement of the UE to access the system. Alternatively, after the UE transmits the SSB request information, and the base station receives the SSB request information and correspondingly transmits the SSB, it is also possible that the SSB transmitted by the base station is not detected by the UE. At this point, the UE may need some time to detect the SSB transmitted by the base station, so as to improve the possibility that the UE successfully detects the SSB. In this case, it is possible to determine an appropriate condition for re-transmitting the SSB request information, and the UE may re-transmit the SSB request information when a condition for retransmitting the SSB request information is satisfied.

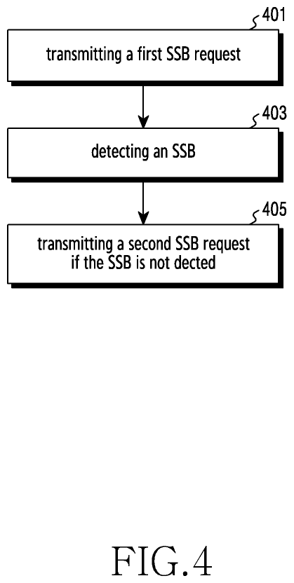

FIG. 4 is a flow diagram illustrating a method performed by a UE according to an embodiment.

Referring to FIG. 4, in step 401, the UE transmits a first SSB request.

In step 403, the UE attempts to detect an SSB, which is transmitted in response to the first SSB request, in order to perform downlink synchronization based on the detected SSB.

In step 405, when failing to detect the SSB in step 403, the UE transmits a second SSB request.

Through the method shown in FIG. 4, the base station can save power, and it is ensured, as much as possible, that the UE can detect the SSB in time.

According to an embodiment, an SSB request, such as the first SSB request or the second SSB request, may be an uplink reference signal. The base station may configure a format, sequence, time-frequency resource, etc., of the uplink reference signal for the SSB request. The UE may receive these information through signaling when being in a connection state, or the UE may preset and determine this information through a protocol. Herein, the signaling may refer to system information, higher-layer signaling, media-access-control (MAC) layer signaling, physical-layer signaling such as downlink control information (DCI), etc.

According to an embodiment, the SSB request may be transmitted through a random access channel. The base station may configure a preamble specialized for an SSB request and transmit the preamble to the UE through signaling. The UE then transmits the SSB request through the random access channel according to the acquired preamble.

According to an embodiment, the SSB request may be uplink control information (UCI). In the connection state, the UE may request a new secondary cell (Scell) to transmit the UCI or a MAC control element (CE) through a primary cell (Pcell). The UCI or MAC CE may carry 1-bit information. For example, if the 1-bit information is 0, it represents that the UCI is the SSB request, and if the 1-bit information is 1, it represents no SSB request.

According to an embodiment, if the SSB transmitted by the base station is not detected within a first time interval after the UE transmits the first SSB request, the UE transmits the second SSB request, i.e., either the base station has not received the first SSB request and therefore, not transmitted the SSB, or the UE has not detected the SSB that was transmitted by the base station after receiving the first SSB request.

When failing to detect the SSB, the UE may not necessarily transmit the second SSB request immediately after the expiration of the first time interval after the transmission of the first SSB request, but may transmit the second SSB request in a first available time unit for transmission of an SSB request after the expiration of the first time interval after the original transmission of the first SSB request. Here, the available time unit for transmission of the SSB request may be determined according to a resource scheduling method. For example, in addition to the format and sequence of the uplink reference signal for the SSB request, the base station may configure the time-frequency resource, etc.

When in the connection state, the UE may receive the time-frequency resource through signaling. Therefore, when failing to detect the SSB, the UE may transmit a second SSB request in the first available time unit after the expiration of the first time interval, after the transmission of the first SSB request.

Based on the foregoing, it is possible to ensure, as much as possible, that a base station transmits an SSB in time, while allow an appropriate time for a UE to successfully detect the SSB, thereby saving the resources occupied and energy consumed by the UE to transmit the request information as much as possible while ensuring that the SSB request is received.

Herein, “time interval,” “time offset” and “time delay” are used interchangeably, meaning a period of time.

Additionally, a time unit is described above by taking a time slot as an example. However, the time unit is not limited to the time slot, but may include any one of the time slot, a sub-time slot, or a symbol (e.g., an orthogonal frequency division multiplexing (OFDM) symbol).

According to an embodiment, the UE may receive, from the base station, signaling to acquire a first time interval between the time unit for the transmission of the first SSB request and the time unit for the transmission of the second SSB request, or the UE may preset and determine the first time interval through a protocol.

Herein, the signaling may refer to system information, higher-layer signaling, MAC layer signaling, physical-layer signaling such as DCI, etc.

When in a connection state, the UE may receive the first time interval through signaling. During the first time interval after the time unit for the transmission of the first SSB request, if the UE fails to detect an SSB, the UE transmits the second SSB request. However, during the first time interval after the time unit for the transmission of the first SSB request information, if the UE detects the SSB, the UE will not transmit the second SSB request information.

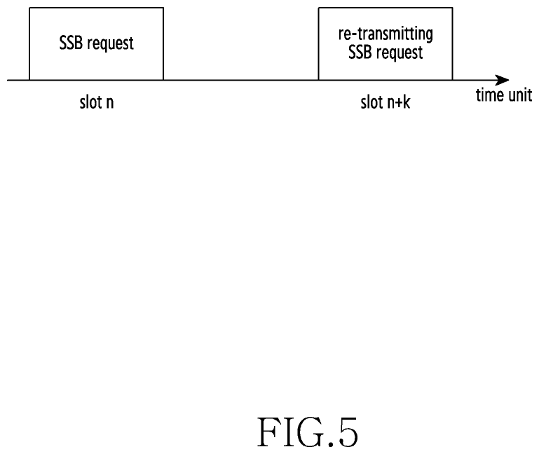

FIG. 5 illustrates a method performed by a UE according to an embodiment.

Referring to FIG. 5, the time unit in which the UE transmits the SSB request (i.e., transmits the first SSB request) is the time slot n, and the time unit in which the UE re-transmits the SSB request (i.e., transmits the second SSB request) is the time slot n+k. The UE may obtain a time interval k by receiving signaling (e.g., higher-layer signaling, MAC layer signaling, or physical-layer signaling) in the connection state, or preset and determine the time interval k through a protocol. The unit of the time interval k may refer to the time slot of the serving cell or bandwidth in which the UE transmits the SSB request information.

Alternatively, the unit of the time interval k may refer to the OFDM symbol of the serving cell or bandwidth in which the UE transmits the SSB request information, or the unit of the time interval k may be milliseconds or microseconds.

Based on the foregoing, the time interval k from the transmission of the SSB request to the re-transmission of the SSB request may be flexibly determined by the base station or through a protocol as appropriate.

According to an embodiment, after receiving the SSB request information transmitted by the UE, the base station may periodically transmit the SSB in a period of time. After the period of time elapses, the base station stops transmitting the SSB. Under the circumstances, the first time interval may be determined based on a period over which the base station transmits an SSB burst and a number of times the base station periodically transmits the SSB burst, and the period over which the base station transmits the SSB burst and the number of times the base station periodically transmits the SSB burst may be preset through a protocol, or may be acquired from the base station by receiving signaling (e.g., higher-layer signaling, media-access-layer signaling, or physical-layer signaling).

When in the connection state, the UE may receive, through signaling, the period over which the base station transmits the SSB burst and the number of times the base station periodically transmits the SSB burst.

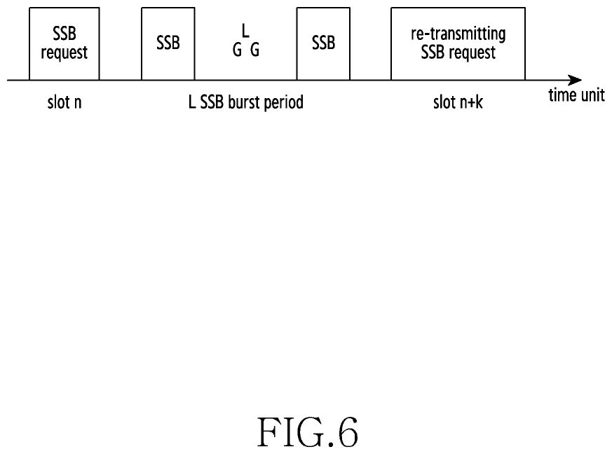

FIG. 6 illustrates a method performed by a UE according to an embodiment.

Referring to FIG. 6, the UE may receive signaling (in a connection state to determine the period over which the base station transmits the SSB burst and the number of times L the base station periodically transmits the SSB burst, or the UE may preset and determine, through a protocol, the period over which the base station transmits the SSB burst and the number of times L the base station periodically transmits the SSB burst. The UE may set the first time interval between the time unit for the transmission of an SSB request (i.e., the transmission of the first SSB request) and the time unit for the re-transmission of the SSB request (i.e., the transmission of the second SSB request) to L transmission periods of the SSB burst, to ensure that there are L opportunities for the UE to detect the SSB, as shown in FIG. 6.

In this way, if the UE does not detect the SSB during the time interval (i.e. the L transmission periods of the SSB burst) after the transmission of the SSB request, the UE re-transmits the SSB request. If the UE detects the SSB during the time interval (i.e. the L transmission periods of the SSB burst) after the transmission of the SSB request, the UE will not re-transmit the SSB request.

For example, the UE determines that the period of the SSB burst is 20 milliseconds (ms) by receiving signaling in the connection state, or presets and determines that the period of the SSB burst is 20 ms through a protocol. The UE presets and determines that the number of times L is 4 through a protocol, or determines that the number of times L is 4 by receiving higher-layer signaling. In this case, if the UE does not detect the SSB within 80 ms after the transmission of the SSB request, the UE will re-transmit the SSB request.

In this way, it is possible to ensure, as much as possible, that the base station transmits the SSB in time, and while giving the UE sufficient opportunities to detect the SSB.

According to an embodiment, the first time interval between the UE transmitting the first SSB request to transmitting the second SSB request may include a second time interval after the transmission of the first SSB request and a third time interval after the second time interval. Here, the second time interval is preset through a protocol, or is acquired by the UE from the base station by receiving signaling. The third time interval may be determined based on the period over which the base station transmits the SSB burst and the number of times the base station periodically transmits the SSB burst. The period over which the base station transmits the SSB burst and the number of times the base station transmits the SSB burst may be preset through a protocol, or may be acquired from the base station by receiving signaling. The UE may receive, through signaling, the second time interval, the period over which the base station transmits the SSB burst and the number of times the base station periodically transmits the SSB burst when being in the connection state.

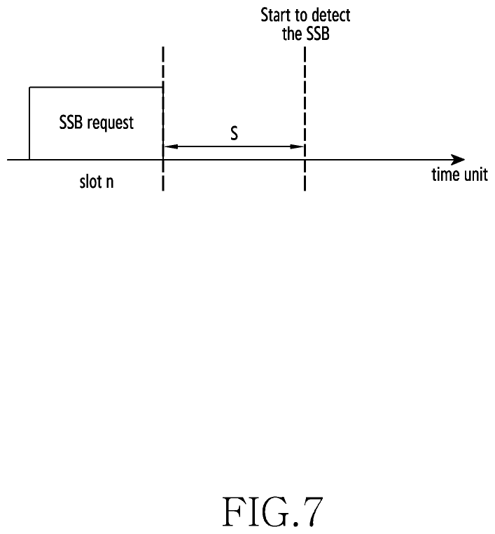

FIG. 7 illustrates a method performed by a UE according to an embodiment.

Referring to FIG. 7, the UE may start to detect the SSB after the second time interval S after the transmission of the SSB request (i.e., the transmission of the first SSB request). The second time interval S may be acquired by receiving signaling, or may be preset and determined through a protocol. The UE may receive the second time interval S through signaling when in the connection state.

According to an embodiment, after receiving the SSB request transmitted by the UE, the base station may periodically transmit the SSB over a period of time. After the period of time elapses, the base station stops transmitting the SSB. At this point, the third time interval may be determined based on the period over which the base station transmits the SSB burst and the number of times the base station periodically transmits the SSB burst. The period over which the base station transmits the SSB burst and the period over which the base station transmits the SSB may be preset through a protocol, or may be acquired from the base station by receiving signaling.

When in the connection state, the UE may receive, through signaling, the period over which the base station transmits the SSB burst and the number of times the base station periodically transmits the SSB burst. If the UE does not detect the SSB after the second time interval and the third time interval after transmitting the SSB, the UE will re-transmit the SSB request information.

The second time interval may include an SSB request reception processing time and/or an SSB transmission preparation time of the base station.

After the UE transmits the SSB request, the base station takes a processing time t1 to receive the SSB request. After successfully receiving the SSB request, the base station takes a time t2 to prepare for the transmission of the SSB before re-transmitting the SSB. The UE may determine the time t1 and the time t2 by receiving signaling in the connection state, or may preset and determine the time t1 and the time t2 through a protocol, and then, the UE may use the time offset t=t1+t2 as the time interval S between the time at which the transmission of the SSB request terminates and the time at which the UE starts to detect the SSB. The unit of the time offset or time interval may be a time slot, an OFDM symbol, ms, or microseconds.

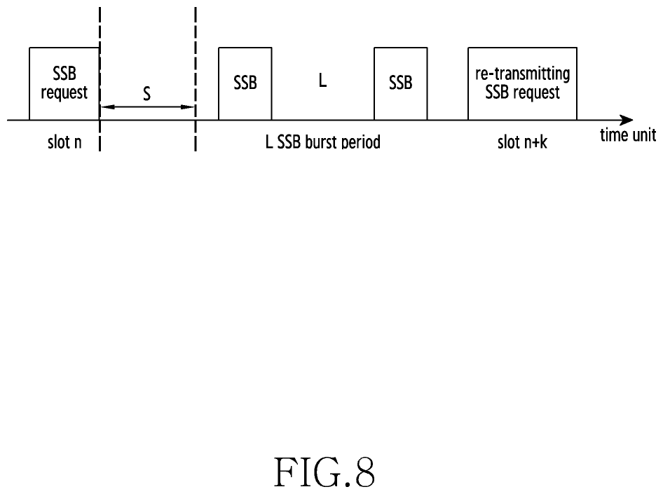

FIG. 8 illustrates a method performed by a UE according to an embodiment.

Referring to FIG. 8, the UE may obtain the SSB burst period of the base station by receiving signaling in the connection state, or preset and determine the SSB burst period of the base station through a protocol. For example, the UE determines that the SSB burst period is 20 ms by receiving signaling, or presets and determines that the SSB burst period is 20 ms through a protocol.

The UE may obtain the number of times L the base station periodically transmits the SSB by receiving signaling in the connection state, or preset and determine the number of times L the base station periodically transmits the SSB through a protocol. For example, the UE presets and determines that the number of times L is 4 through the protocol. Alternatively, the UE may determine that the number of times L is 4 by receiving the higher-layer signaling.

After the UE transmits the SSB request (i.e., the first SSB request) in the time slot n, the base station takes a processing time to receive the SSB request information, and the base station also takes a time to prepare for the transmission of the SSB. The processing time taken by the base station to receive the SSB request and the time taken by the base station to prepare for the transmission of the SSB may be referred to as the SSB delay S. If the SSB is not detected by the UE after L SSB burst periods after the time slot n+S after transmitting the SSB request in the time slot n, the UE may re-transmit the SSB request (i.e., transmit the second SSB request).

As illustrated in FIG. 8, the base station can be requested to transmit the SSB in time, and the performance of the UE in detecting the SSB can be ensured.

According to the above-described embodiments, the UE may detect the SSB transmitted by the base station.

The UE may measure the signal strength of a reference signal used to detect the SSB, in order to determine whether the SSB is detected. For example, if the measured signal strength is greater than or equal to a predetermined threshold, it is determined that the SSB is detected; otherwise, it is determined that the SSB is not detected.

The UE may determine whether the SSB is detected through the signal strength of the reference signal used to detect the SSB. For example, if the signal strength of the reference signal used to detect the SSB, as measured by the UE, is greater than or equal to a specified threshold, it may be determined that the base station receives the SSB request information and transmits the SSB.

The reference signal used by the UE to detect the SSB signal strength may be a PSS, an SSS, or a DMRS of a PBCH. The threshold of the SSB signal strength may be obtained by receiving signaling by the UE in the connection state, or may be preset and determined through a protocol.

Based on the foregoing, the UE can determine, as soon as possible, whether the base station receives the SSB request information and transmits the SSB accordingly.

The UE may detect the PSS and the SSS in the SSB. If the physical-layer cell identity (PCI) of the serving cell is obtained through the PSS and the SSS, it is determined that the SSB is detected; otherwise, it is determined that the SSB is not detected.

In this way, the UE can quickly determine whether the base station receives the SSB request information and transmits the SSB accordingly, while reducing the possibility that the UE makes an erroneous determination.

The UE may detect the PSS and the SSS in the SSB. If the PCI of the serving cell is obtained through the PSS and the SSS and the PBCH is successfully demodulated, it is determined that the SSB is detected; otherwise, it is determined that the SSB is not detected.

In this way, the UE can determine whether the base station receives the SSB request information and transmits the SSB accordingly, and at the same time, the possibility that the UE makes an erroneous determination is reduced.

The UE may first measure the signal strength of the reference signal (e.g., the PSS, the SSS, or the DMRS of the PBCH) used to detect the SSB, to determine whether the SSB is detected, and then detect the PSS and the SSS in the SSB if the measured signal strength is greater than or equal to the predetermined threshold. If the PCI of the serving cell is obtained through the PSS and the SSS, it is determined that the SSB is detected; otherwise, it is determined that the SSB is not detected.

The UE may first measure the signal strength of the reference signal (e.g., the PSS, the SSS, or the DMRS of the PBCH) used to detect the SSB, to determine whether the SSB is detected, and then detect the PSS and the SSS in the SSB if the measured signal strength is greater than or equal to the predetermined threshold. If the PCI of the serving cell is obtained through the PSS and the SSS and the PBCH is successfully demodulated, it is determined that the SSB is detected; otherwise, it is determined that the SSB is not detected.

The above methods described in the present disclosure may be performed by a UE including a transceiver and a processor.

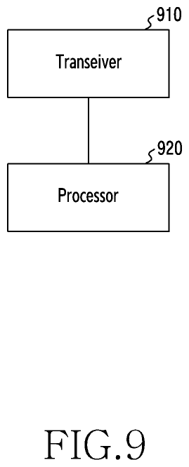

FIG. 9 illustrates a UE according to an embodiment.

Referring to FIG. 9, the UE includes a transceiver 910, and a processor 920 coupled to the transceiver 910. The transceiver 910 is configured to transmit and receive a signal. The processor 920 is configured to perform one or more of the operations of the above-described embodiments. For example, the processor 920 is configured to transmit a first SSB request; attempt to detect an SSB; and transmit a second SSB request, if the SSB is not detected.

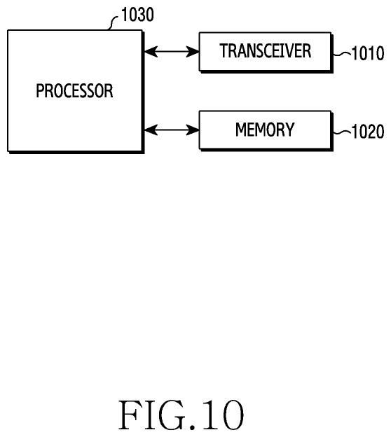

FIG. 10 illustrates a UE according to an embodiment.

Referring to FIG. 10, the UE includes a transceiver 1010, a memory 1020, and a processor 1030. The transceiver 1010, the memory 1020, and the processor 1030 may operate according to at least one of the communication methods of the UE as described above.

The components of the UE are not limited to those illustrated in FIG. 10. For example, the UE may include more or fewer components than those described above.

In addition, the processor 1030, the transceiver 1010, and the memory 1020 may be implemented as a single chip. Also, the processor 1030 may include at least one processor.

The transceiver 1010 collectively refers to a receiver and a transmitter, and may transmit/receive a signal to/from a base station. The signal transmitted or received to or from the base station may include control information and data. The transceiver 1010 may include an RF transmitter for up-converting and amplifying a frequency of a transmitted signal, and an RF receiver for amplifying low-noise and down-converting a frequency of a received signal. However, this is only an example of the transceiver 1010 and components of the transceiver 1010 are not limited to the RF transmitter and the RF receiver.

The transceiver 1010 may also receive and output, to the processor 1030, a signal through a wireless channel, and transmit a signal output from the processor 1030 through the wireless channel.

The memory 1020 may store a program and data required for operations of the UE. The memory 1020 may store control information or data included in a signal obtained by the UE. The memory 1020 may be a storage medium, such as ROM, RAM, a hard disk, a compact disc (CD)-ROM, a digital versatile disc (DVD), or a combination of storage media.

The processor (e.g. controller) 1030 may control a series of processes such that the UE operates as described above. For example, the transceiver 1010 may receive a data signal including a control signal transmitted by the base station, and the processor 1030 may determine a result of receiving the control signal and the data signal transmitted by the base station.

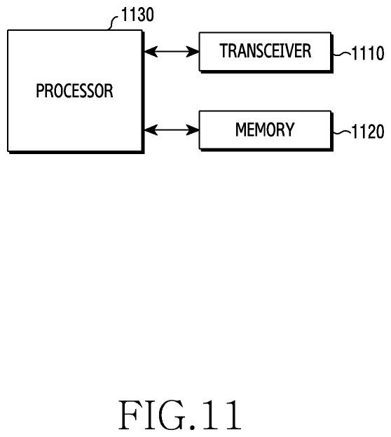

FIG. 11 illustrates a base station according to an embodiment.

Referring to FIG. 11, the base station includes a transceiver 1110, a memory 1120, and a processor 1130. The transceiver 1110, the memory 1120, and the processor 1130 of the base station may operate according to at least one of the communication methods of the base station described above.

The components of the base station are not limited thereto. For example, the base station may include more or fewer components than those described above.

In addition, the processor 1130, the transceiver 1110, and the memory 1120 may be implemented as a single chip. Also, the processor 1130 may include at least one processor.

The transceiver 1110 collectively refers to a receiver and a transmitter, and may transmit/receive a signal to/from a terminal. The signal transmitted or received to or from the terminal may include control information and data. The transceiver 1110 may include an RF transmitter for up-converting and amplifying a frequency of a transmitted signal, and an RF receiver for amplifying low-noise and down-converting a frequency of a received signal. However, this is only an example of the transceiver 1110 and components of the transceiver 1110 are not limited to the RF transmitter and the RF receiver.

The transceiver 1110 may also receive and output, to the processor 1130, a signal through a wireless channel, and transmit a signal output from the processor 1130 through the wireless channel.

The memory 1120 may store a program and data required for operations of the base station. The memory 1120 may store control information or data included in a signal obtained by the base station. The memory 1120 may be a storage medium, such as ROM, RAM, a hard disk, a CD-ROM, a DVD, or a combination of storage media.

The processor (e.g., a controller) 1130 may control a series of processes such that the base station operates as described above. For example, the transceiver 1110 may receive a data signal including a control signal transmitted by the terminal, and the processor 1130 may determine a result of receiving the control signal and the data signal transmitted by the terminal.

The disclosure may alternatively be implemented as a computer storage medium. The computer storage medium stores a computer instruction. The computer instruction, when executed, e.g., by the processor 920 in the UE of FIG. 9, causes the processor 920 to perform one or more of the operations in the above-described embodiments.

According to an embodiment, a method performed by a base station in a communication system may include receiving a first SSB request, transmitting an SSB in response to receiving the first SSB request; receiving a second SSB request, in response to the SSB not being detected; and re-transmitting the SSB based on the second SSB request.

The method performed by the base station may further include transmitting signaling including a first time interval to a UE, wherein the SSB not being detected is determined according to the first time interval.

The method performed by the base station may further include transmitting, to the UE, a period of an SSB burst and a number of times the SSB burst is periodically transmitted, wherein the SSB not being detected is determined according to the first time interval determined by the period and the number of times.

The method performed by the base station may further include transmitting, to the UE, a second time interval, the period of the SSB burst and the number of times the SSB burst is periodically transmitted, wherein the SSB not being detected is determined according to the second time interval and a third time interval. The third time interval is determined by the period and the number of times.

The method performed by the base may further include transmitting, to the UE, an SSB request reception processing time and an SSB transmission preparation time, wherein the second time interval is determined according to the SSB request reception processing time and/or the SSB transmission preparation time.

The base station may receive the SSB request through an uplink reference signal or UCI, or through signaling transmitted through a random access channel.

The above-described methods in the disclosure may be performed by a base station including a transceiver and a processor. The processor is configured to receive a first SSB request, transmit an SSB in response to the first SSB request being received, receive a second SSB request, in response to the SSB not being detected, and re-transmit the SSB based on the second SSB request.

Herein, “at least one” includes any and/or all possible combinations of the listed items, the various embodiments described in the present disclosure and the various examples in the embodiments may be varied and combined in any suitable form, and “/” described in the present disclosure represents “and/or.”

The various illustrative logical blocks, modules, and circuits described in the present disclosure may be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. The general purpose processor may be a microprocessor, but in an alternative scheme, the processor may be any conventional processor, controller, microcontroller, or state machine. The processor may alternatively be implemented as a combination of computing devices, e.g., a combination of a DSP and a microprocessor, a plurality of microprocessors, one or more microprocessors in collaboration with a DSP core, or any other such configuration.

The steps of the method or algorithm described in the present disclosure may be embodied directly in hardware, in a software module executed by the processor, or in a combination of the two. The software module may reside in a RAM memory, a flash memory, a ROM memory, an erasable programmable ROM (EPROM) memory, an electrically EPROM (EEPROM) memory, a register, a hard disk, a removable disk, or any other form of storage medium known in the art. An exemplary storage medium is coupled to the processor, to enable the processor to read information from/write information to the storage medium. In an alternative scheme, the storage medium may be integrated to the processor. The processor and the storage medium may reside in an ASIC. The ASIC may reside in a user terminal. In an alternative scheme, the processor and the storage medium may reside as discrete components in a user terminal.

In one or more exemplary designs, the functions described may be implemented in hardware, software, firmware, or any combination thereof. If implemented in software, the functions may be stored on or transmitted over a computer readable medium as one or more instructions or code. The computer readable medium includes both a computer storage medium and a communication medium, the communication medium including any medium that facilitates the transfer of a computer program from one place to another. The storage medium may be any available medium that can be accessed by a general purpose or special purpose computer.

Example configurations, methods and apparatuses are described in combination with the accompanying drawings in description set forth herein, and do not represent all the examples that may be implemented or that are within the scope of the claims. The term “exemplary” used herein means “serving as an example, instance, or illustration,” rather than “preferred” or “advantageous over other examples.” The detailed description includes specific details for the purpose of providing an understanding of the described techniques. These techniques, however, may be practiced without these specific details. In some instances, well-known structures and devices are shown in the form of a block diagram in order to avoid obscuring the concepts of the described examples.

This specification contains many specific implementation details, but the implementation details should not be construed as a limitation to the scope of any disclosure or the scope claimed, but rather as a description for specific features in a specific embodiment of the specific disclosure. Certain features described in the context of separate embodiments in this specification may alternatively be implemented in combination in a single embodiment. Rather, the various features described in the context of a single embodiment may be implemented separately in a plurality of embodiments or implemented in any suitable sub-combination. Furthermore, the features may be described as functioning in certain combinations in the context, and even initially so claimed, but in some cases one or more features in a claimed combination may be deleted from the combination, and the claimed combination may be directed to a sub-combination or the variation of the sub-combination.

The specific order or hierarchy of steps in the method in the present disclosure is an illustration for an exemplary process. Based on design preferences, it may be understood that the specific order or hierarchy of the steps in the method may be rearranged to achieve the functions and effects disclosed in the present disclosure. The accompanying method claims present the elements of various steps in example order, but are not intended to be limited to the specific order or hierarchy presented, unless specifically stated otherwise. Furthermore, although an element may be described or claimed in a singular form, the plural can also be expected unless the limitation to the singular is explicitly stated. Thus, the present disclosure is not limited to the examples shown, and any apparatus for performing the functions described herein is included in the aspects of the present disclosure.

The text and drawings are provided as examples only to help readers understand the present disclosure. They are not intended and should not be interpreted as limiting the scope of the present disclosure in any way.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

What is claimed is:

1. A method performed by a user equipment (UE) in a wireless communication system, the method comprising:
transmitting, to a base station, a first synchronization signal block (SSB) request;
receiving, from the base station, an SSB; and
in case that the SSB is not detected within a first time interval after transmitting the first SSB request, transmitting, to the base station, a second SSB request.

2. The method of claim 1, wherein the first time interval is preset through a protocol.

3. The method of claim 1, wherein the first time interval is determined based on a period over which the base station transmits an SSB burst and a number of times the base station periodically transmits the SSB burst, and
wherein the period and the number of times are preset.

4. The method of claim 1, wherein the first time interval includes a second time interval after transmitting the first SSB request and a third time interval after the second time interval,
wherein the third time interval is determined based on a period over which the base station transmits an SSB burst and a number of times the base station periodically transmits the SSB burst, and
wherein the second time interval, the period, and the number of times are preset.

5. The method of claim 1, wherein at least one of the first SSB request or the second SSB request is transmitted via at least one of an uplink reference signal, uplink control information, or a random access channel.

6. A method performed by a base station in a wireless communication system, the method comprising:
receiving, from a user equipment (UE), a first synchronization signal block (SSB) request;
transmitting, to the UE, an SSB; and
in case that the SSB is not detected by the UE within a first time interval after transmitting the first SSB request, receiving, from the UE, a second SSB request.

7. The method of claim 6, wherein the first time interval is preset.

8. The method of claim 6, wherein the first time interval is determined based on a period over which the base station transmits an SSB burst and a number of times the base station periodically transmits the SSB burst, and
wherein the period and the number of times are preset.

9. The method of claim 6, wherein the first time interval includes a second time interval after transmitting the first SSB request and a third time interval after the second time interval,
wherein the third time interval is determined based on a period over which the base station transmits an SSB burst and a number of times the base station periodically transmits the SSB burst, and
wherein the second time interval, the period, and the number of times are preset.

10. The method of claim 6, wherein at least one of the first SSB request or the second SSB request is received via at least one of an uplink reference signal, uplink control information, or a random access channel.

11. A user equipment (UE) for use in a wireless communication system, the UE comprising:
a transceiver; and
a controller coupled to the transceiver, and configured to:
transmit, to a base station, a first synchronization signal block (SSB) request,
receive, from the base station, an SSB, and
in case that the SSB is not detected within a first time interval after transmitting the first SSB request, transmit, to the base station, a second SSB request.

12. The UE of claim 11, wherein the first time interval is preset.

13. The UE of claim 11, wherein the first time interval is determined based on a period over which the base station transmits an SSB burst and a number of times the base station periodically transmits the SSB burst, and
wherein the period and the number of times are preset.

14. The UE of claim 11, wherein the first time interval includes a second time interval after transmitting the first SSB request and a third time interval after the second time interval,
wherein the third time interval is determined based on a period over which the base station transmits an SSB burst and a number of times the base station periodically transmits the SSB burst, and
wherein the second time interval, the period and the number of times are preset.

15. The UE of claim 11, wherein at least one of the first SSB request or the second SSB request is transmitted via at least one of an uplink reference signal, uplink control information, or a random access channel.

16. A base station for use in a wireless communication system, the base station comprising:
a transceiver; and
a controller coupled to the transceiver, and configured to:
receive, from a user equipment (UE), a first synchronization signal block (SSB) request,
transmit, to the UE, an SSB, and
in case that the SSB is not detected by the UE within a first time interval after transmitting the first SSB request, receive, from the UE, a second SSB request.

17. The base station of claim 16, wherein the first time interval is preset.

18. The base station of claim 16, wherein the first time interval is determined based on a period over which the base station transmits an SSB burst and a number of times the base station periodically transmits the SSB burst, and
wherein the period and the number of times are preset.

19. The base station of claim 16, wherein the first time interval includes a second time interval after transmitting the first SSB request and a third time interval after the second time interval,
wherein the third time interval is determined based on a period over which the base station transmits an SSB burst and a number of times the base station periodically transmits the SSB burst, and
wherein the second time interval, the period and the number of times are preset.

20. The base station of claim 16, wherein at least one of the first SSB request or the second SSB request is received via at least one of an uplink reference signal, uplink control information, or a random access channel.
